(19) United States
(12) Patent Application Publication
(10) Pub. No.: US 2013/0052381 A1
(43) Pub. Date: Feb. 28, 2013

(54) POLYEPOXIDES AND EPOXY RESINS AND METHODS FOR THE MANUFACTURE AND USE THEREOF

(71) Applicants: Robert R. Gallucci, Mt. Vernon, IN (US); James A. Mahood, Evansville, IN (US); Jean Francois Morizur, Evansville, IN (US); Steve Dimond, Bedford, NH (US)

(72) Inventors: Robert R. Gallucci, Mt. Vernon, IN (US); James A. Mahood, Evansville, IN (US); Jean Francois Morizur, Evansville, IN (US); Steve Dimond, Bedford, NH (US)

(21) Appl. No.: 13/564,348

(22) Filed: Aug. 1, 2012

Related U.S. Application Data
(60) Provisional application No. 61/526,029, filed on Aug. 22, 2011.

(51) Int. Cl. C08G 59/02; C08L 63/02; C08G 59/04; B32B 1/02; B32B 27/38; B32B 27/06; B32B 15/092; C08L 63/00; C08K 11/00

(52) U.S. Cl. 428/35.7; 528/206; 528/219; 528/212; 524/599; 524/611; 528/100; 528/87; 528/96; 428/413; 428/417; 428/418

(57) ABSTRACT

This disclosure relates to epoxides, polyepoxide compositions and epoxy resins whose degradation products exhibit little or no estradiol binding activity. Also disclosed are methods for making the disclosed compositions and articles of manufacture comprising the disclosed compositions.

### CROSS REFERENCE TO RELATED APPLICATIONS

This application claims the benefit of priority to U.S. Provisional Application No. 61/526,029, filed Aug. 22, 2011, which is hereby incorporated by reference in its entirety.

### FIELD OF THE INVENTION

The present disclosure relates to polyepoxide compositions having, among other characteristics, significantly reduced or even no measurable level of estradiol like binding activity. Also included herein are methods for preparing and/or using the same, as well as articles formed from such compositions and blends

### BACKGROUND OF THE INVENTION

Polyepoxides (also known as epoxies) are thermosetting polymers generally formed from reaction of an epoxide resin with, for instance, a polyamine hardener. The applications for epoxy-based materials are extensive and include coatings, adhesives and composite materials such as those using carbon fiber and fiberglass reinforcements. The chemistry of epoxies and the range of commercially available variations allows cure polymers to be produced with a very broad range of properties. In general, epoxies are known for their excellent adhesion, chemical and heat resistance, excellent mechanical properties and very good electrical insulating properties. Variations offering high thermal insulation, or thermal conductivity combined with high electrical resistance for electronics applications, are also obtainable.

Despite the aforementioned advantages, when subjected to certain conditions, polyepoxides can undergo various degradation reactions, such as hydrolytic and thermal degradation, resulting in the formation of degradation products, including hydrolysis degradants or thermolysis degradants. The resulting degradants commonly correspond to the monomeric starting materials initially used to manufacture the polyepoxides. The presence of residual phenolic monomers either as residues of polymerization or through degradation by thermal or hydrolytic means, is an area of growing regulatory concern. To that end, there remains a need in the art for thermoplastic polyepoxide compositions whose residual monomers or hydrolytic or thermal degradation products exhibit certain beneficial characteristics. Desirable characteristics of such degradants include, among others, relatively little or even no estradiol binding activity.

### SUMMARY OF THE INVENTION

This invention relates generally to polyepoxide compositions derived from the aromatic dihydroxy compounds that exhibit relatively little or even no estradiol binding activity. Thus, hydrolytic degradation products resulting from the hydrolysis of the disclosed polyepoxide or thermal degradation products resulting from the thermolysis of the disclosed polyepoxide, similarly exhibit relatively little or even no estradiol binding activity.

In a first aspect, the invention generally provides a polyepoxide composition comprising a polymerized bisepoxide, wherein the bisepoxide is derived from an aromatic dihydroxy compound that does not exhibit a half maximal inhibitory concentration (IC₅₀) less than 0.00025M for alpha or beta in vitro estradiol receptors. Still further, when the polymerized bisepoxide is subjected to conditions effective to provide one or more degradation products, each of the one or more degradation products does not exhibit a half maximal inhibitory concentration (IC₅₀) less than 0.00025M for alpha or beta in vitro estradiol receptors.

In another aspect, the present invention is an epoxy resin composition comprising a copolymerized bisepoxide component and aromatic dihydroxy component. The bisepoxide component comprises a bisepoxide compound derived from a first aromatic dihydroxy compound that does not exhibit a half maximal inhibitory concentration (IC₅₀) less than 0.00025M for alpha or beta in vitro estradiol receptors. The aromatic dihydroxy component comprises a second aromatic dihydroxy compound that also does not exhibit a half maximal inhibitory concentration (IC₅₀) less than 0.00025M for alpha or beta in vitro estradiol receptors. Still further, when the epoxy resin composition is subjected to conditions effective to provide one or more degradation products, such as a hydrolysis or thermolysis reaction, each of the one or more degradation products does not exhibit a half maximal inhibitory concentration (IC₅₀) less than 0.00025M for alpha and/or beta in vitro estradiol receptors.

In another aspect, the present invention provides a method for the manufacture of a polyepoxide composition. The method generally comprises providing an aromatic dihydroxy compound that does not exhibit a half maximal inhibitory concentration (IC₅₀) less than 0.00025M for alpha and/or beta in vitro estradiol receptors and reacting the provided aromatic dihydroxy compound with an epoxide forming reactant to provide a bisepoxide that is derived from the aromatic dihydroxy compound. The resulting bisepoxide is the polymerized to provide a polyepoxide composition having any desired predetermined molecular weight.

In still another aspect, the present invention provides a method for the manufacture of an epoxy resin. The method according to this aspect comprises the step of providing a first aromatic dihydroxy compound that does not exhibit a half maximal inhibitory concentration (IC₅₀) less than 0.00025M for alpha or beta in vitro estradiol receptors and reacting the first aromatic dihydroxy compound with an epoxide forming reactant to provide a bisepoxide derived from the aromatic dihydroxy compound. The resulting bis epoxides is then copolymerized with a second aromatic dihydroxy compound that similarly does not exhibit a half maximal inhibitory concentration (IC₅₀) less than 0.00025M for alpha or beta in vitro estradiol receptors to provide an epoxy resin composition having any predetermined molecular weight.

Additional aspects of the invention provide various articles of manufacture comprising the disclosed bisepoxides, polyepoxides, phenoxy resins and epoxy resin compositions.

Additional advantages will be set forth in part in the description which follows. The advantages will be realized and attained by means of the elements and combinations particularly pointed out in the appended claims. It is to be understood that both the foregoing general description and the following detailed description are exemplary and explanatory only and are not restrictive, as claimed.

### DETAILED DESCRIPTION OF THE INVENTION

The present invention can be understood more readily by reference to the following detailed description, examples, drawings, and claims, and their previous and following description. However, before the present compositions, compounds, devices, systems, and/or methods are disclosed and described, it is to be understood that this invention is not limited to the specific compositions, compounds, devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those of ordinary skill in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those of ordinary skill in the relevant art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to an “aromatic dihydroxy monomer” can include two or more such monomers unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular approximated value forms another aspect of the invention. It will be further understood that the endpoints of each of the ranges are significant both in relation to the other endpoint, and independently of the other endpoint.

All ranges disclosed herein are inclusive of the endpoints and are independently combinable. The endpoints of the ranges and any values disclosed herein are not limited to the precise range or value; they are sufficiently imprecise to include values approximating these ranges and/or values. Ranges articulated within this disclosure, e.g. numerics/values, shall include disclosure for possession purposes and claim purposes of the individual points within the range, sub-ranges, and combinations thereof. As an example, for the recitation of numeric ranges herein, each intervening number there between with the same degree of precision is explicitly contemplated—for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

Various combinations of elements of this disclosure are encompassed by this invention, e.g. combinations of elements from dependent claims that depend upon the same independent claim.

As used herein, the terms “optional” or “optionally” mean that the subsequently described event, condition, component, or circumstance may or may not occur, and that the description includes instances where said event or circumstance occurs and instances where it does not.

A weight percent of a component, unless specifically stated to the contrary, is based on the total weight of the formulation or composition in which the component is included.

A residue of a chemical species, as used in the specification and concluding claims, refers to the moiety that is the resulting product of the chemical species in a particular reaction scheme or subsequent formulation or chemical product, regardless of whether the moiety is actually obtained from the chemical species. Thus, an ethylene glycol residue in a polyester refers to one or more —OCH₂CH₂O— units in the polyester, regardless of whether ethylene glycol was used to prepare the polyester. Similarly, a sebacic acid residue in a polyester refers to one or more —CO(CH₂)₈CO— moieties in the polyester, regardless of whether the residue is obtained by reacting sebacic acid or an ester thereof to obtain the polyester.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, the aldehyde group —CHO is attached through the carbon of the carbonyl group.

The term “aliphatic” refers to a linear or branched array of atoms that is not cyclic and has a valence of at least one. Aliphatic groups are defined to comprise at least one carbon atom. The array of atoms may include heteroatoms such as nitrogen, sulfur, silicon, selenium and oxygen or may be composed exclusively of carbon and hydrogen (“Alkyl”). Aliphatic groups may be substituted or unsubstituted. Exemplary aliphatic groups include, but are not limited to, methyl, ethyl, isopropyl, isobutyl, chloromethyl, hydroxymethyl (—CH₂OH), mercaptomethyl (—CH₂SH), methoxy, methoxycarbonyl (CH₃OCO—), nitromethyl (—CH₂NO₂), and thiocarbonyl.

The term “alkyl group” as used herein is a branched or unbranched saturated hydrocarbon group of 1 to 24 carbon atoms, such as methyl, ethyl, n-propyl, isopropyl, n-butyl, isobutyl, t-butyl, pentyl, hexyl, heptyl, octyl, decyl, tetradecyl, hexadecyl, eicosyl, tetracosyl and the like. A “lower alkyl” group is an alkyl group containing from one to six carbon atoms.

The term “alkoxy” as used herein is an alkyl group bound through a single, terminal ether linkage; that is, an “alkoxy” group can be defined as —OR where R is alkyl as defined above. A “lower alkoxy” group is an alkoxy group containing from one to six carbon atoms.

The term “alkenyl group” as used herein is a hydrocarbon group of from 2 to 24 carbon atoms and structural formula containing at least one carbon-carbon double bond. Asymmetric structures such as (AB)C═C(CD) are intended to include both the E and Z isomers. This can be presumed in structural formulae herein wherein an asymmetric alkene is present, or it can be explicitly indicated by the bond symbol C.

The term “alkynyl group” as used herein is a hydrocarbon group of 2 to 24 carbon atoms and a structural formula containing at least one carbon-carbon triple bond.

The term “aryl group” as used herein is any carbon-based aromatic group including, but not limited to, benzene, naphthalene, etc.

The term “aromatic” refers to an array of atoms having a valence of at least one and comprising at least one aromatic group. The array of atoms may include heteroatoms such as nitrogen, sulfur, selenium, silicon and oxygen, or may be composed exclusively of carbon and hydrogen. The aromatic group may also include nonaromatic components. For example, a benzyl group is an aromatic group that comprises a phenyl ring (the aromatic component) and a methylene group (the nonaromatic component). Exemplary aromatic groups include, but are not limited to, phenyl, pyridyl, furanyl, thienyl, naphthyl, biphenyl, 4-trifluoromethylphenyl, 4-chloromethylphen-1-yl, and 3-trichloromethylphen-1-yl (3-CCl₃Ph-).

The term “aromatic” also includes “heteroaryl group,” which is defined as an aromatic group that has at least one heteroatom incorporated within the ring of the aromatic group. Examples of heteroatoms include, but are not limited to, nitrogen, oxygen, sulfur, and phosphorus. The aryl group can be substituted or unsubstituted. The aryl group can be substituted with one or more groups including, but not limited to, alkyl, alkynyl, alkenyl, aryl, halide, nitro, amino, ester, ketone, aldehyde, hydroxy, carboxylic acid, or alkoxy.

The term “cycloalkyl group” as used herein is a non-aromatic carbon-based ring composed of at least three carbon atoms. Examples of cycloalkyl groups include, but are not limited to, cyclopropyl, cyclobutyl, cyclopentyl, cyclohexyl, etc. The term “heterocycloalkyl group” is a cycloalkyl group as defined above where at least one of the carbon atoms of the ring is substituted with a heteroatom such as, but not limited to, nitrogen, oxygen, sulphur, or phosphorus.

The term “aralkyl” as used herein is an aryl group having an alkyl, alkynyl, or alkenyl group as defined above attached to the aromatic group. An example of an aralkyl group is a benzyl group.

The term “hydroxyalkyl group” as used herein is an alkyl, alkenyl, alkynyl, aryl, aralkyl, cycloalkyl, halogenated alkyl, or heterocycloalkyl group described above that has at least one hydrogen atom substituted with a hydroxyl group.

The term “alkoxyalkyl group” is defined as an alkyl, alkenyl, alkynyl, aryl, aralkyl, cycloalkyl, halogenated alkyl, or heterocycloalkyl group described above that has at least one hydrogen atom substituted with an alkoxy group described above.

The term “ester” as used herein is represented by the formula —C(O)OA, where A can be an alkyl, halogenated alkyl, alkenyl, alkynyl, aryl, heteroaryl, cycloalkyl, cycloalkenyl, heterocycloalkyl, or heterocycloalkenyl group described above.

The term “carbonate group” as used herein is represented by the formula —OC(O)OR, where R can be hydrogen, an alkyl, alkenyl, alkynyl, aryl, aralkyl, cycloalkyl, halogenated alkyl, or heterocycloalkyl group described above.

The term “carboxylic acid” as used herein is represented by the formula —C(O)OH.

The term “aldehyde” as used herein is represented by the formula —C(O)H.

The term “keto group” as used herein is represented by the formula —C(O)R, where R is an alkyl, alkenyl, alkynyl, aryl, aralkyl, cycloalkyl, halogenated alkyl, or heterocycloalkyl group described above.

The term “carbonyl group” as used herein is represented by the formula C═O.

The term “integer” means a whole number and includes zero. For example, the expression “n is an integer from 0 to 4” means n may be any whole number from 0 to 4, including 0.

As used herein, the term “epoxide” refers to a cyclic ether with three ring atoms.

As used herein, the term half maximal inhibitory concentration (IC₅₀) is a quantitative measure that indicates how much of a particular substance, i.e., an inhibitor, is needed to inhibit a given biological process or component of a process, by one half. In other words, it is the half maximal (50%) inhibitory concentration (IC) of a substance (50% IC, or IC₅₀). It is commonly known to one of ordinary skill in the art and used as a measure of antagonist drug potency in pharmacological research. The (IC₅₀) of a particular substance can be determined using conventional competition binding assays. In this type of assay, a single concentration of radioligand (such as an agonist) is used in every assay tube. The ligand is used at a low concentration, usually at or below its K_{d} value. The level of specific binding of the radioligand is then determined in the presence of a range of concentrations of other competing non-radioactive compounds (usually antagonists), in order to measure the potency with which they compete for the binding of the radioligand. Competition curves may also be computer-fitted to a logistic function as described under direct fit. The IC₅₀ is the concentration of competing ligand which displaces 50% of the specific binding of the radioligand.

As summarized above, disclosed herein are aromatic dihydroxy compounds that exhibit relatively little or even no estradiol binding activity. More specifically, these aromatic dihydroxy compounds do not exhibit a half maximal inhibitory concentration (IC₅₀) less than 0.00025M for alpha and/or beta in vitro estradiol receptors. According to further embodiments, the disclosed aromatic dihydroxy compounds do not exhibit a half maximal inhibitory concentration (IC₅₀) less than 0.0003M, 0.00035M, 0.0004M, 0.00045M, 0.0005M, 0.00075M, or even 0.001 M, for alpha or beta in vitro estradiol receptors. In still other embodiments, the disclosed aromatic dihydroxy compounds do not exhibit any identifiable half maximal inhibitory concentration (IC₅₀) greater than or equal to about 0.00025M, 0.0003M, 0.00035M, 0.0004M, 0.00045M, 0.0005M, 0.00075M, or even 0.001 M, for alpha and/or beta in vitro estradiol receptors.

The disclosed aromatic dihydroxy compounds can comprise phenolic compounds. These phenolic monomers can comprise dihydric phenols, mono phenols, bisphenols, or a combination thereof. Specific examples of the disclosed aromatic dihydroxy compounds include, without limitation, resorcinol, hydroquinone, methyl hydroquinone, t-butyl hydroquinone, di-t-butyl hydroquinones (DTBHQ), biphenols, tetramethyl bisphenol-A, spiro biindane bisphenols (SBIBP), bis-(hydroxy aryl)-N-aryl isoindolinones, hydroxy benzoic acids, or any combination thereof. It should be understood that, in view of this disclosure, any additional aromatic dihydroxy monomers exhibiting a lack of estradiol binding activity characterized by the half maximal inhibitory concentration values described above can be used.

The disclosed aromatic dihydroxy compounds are particularly well suited for use in the subsequent manufacture of epoxides and, more particularly, bis-epoxides. For example, such aromatic dihydroxy compounds can be reacted with any desired epoxide precursor or epoxides forming reactant according to any conventionally known epoxide forming reaction process to provide an epoxide functionality on the aromatic dihydroxy compound. For example, and without limitation, epichlorohydrin is commonly known for use as an epoxide precursor reactant. To that end, epichlorohydrin can be reacted with the disclosed aromatic dihydroxy compounds to provide an epoxide. As one of ordinary skill in the art will understand, when utilizing epichlorohydrin as the epoxide precursor reactant, the resulting epoxide formed will be a diglycidyl ether. Epoxides can also be made from epoxidation of a dialkenyl phenolic ether, for example a diallyl phenolic ether. Still further, the resulting epoxide will similarly lack any significant estradiol binding activity as characterized by a half maximal inhibitory concentration (IC₅₀), if any, that is not less than 0.00025M for alpha or beta in vitro estradiol receptors. According to further embodiments, the resulting epoxides does not exhibit a half maximal inhibitory concentration (IC₅₀) less than 0.0003M, 0.00035M, 0.0004M, 0.00045M, 0.0005M, 0.00075M, or even 0.001 M, for alpha or beta in vitro estradiol receptors. In still other embodiments, the resulting epoxides does not exhibit any identifiable half maximal inhibitory concentration (IC₅₀) greater than or equal to about 0.00025M, 0.0003M, 0.00035M, 0.0004M, 0.00045M, 0.0005M, 0.00075M, or even 0.001 M, for alpha and/or beta in vitro estradiol receptors.

Exemplary non-limiting aromatic bis epoxides (diglycidyl ethers) that can be obtained from the reaction of disclosed aromatic dihydroxy compounds and epichlorohydrin are set forth below. For example, according to one embodiment, resorcinol can be reacted with epichlorohydrin to provide Resorcinol Diglycidyl Ether (R-DGE) having the general structure:

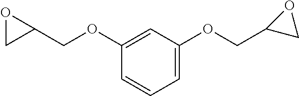 [SMILES: c1cc(OCC2CO2)cc(OCC2CO2)c1]

According to another embodiment, spiro biindane bis phenol can be reacted with epichlorohydrin to provide spiro biindane bis phenol diglycidyl ether (SBIBP-DGE) having the general chemical structure:

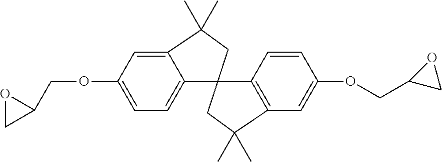 [SMILES: CC1(C)CC2(CC(C)(C)c3cc(OCC4CO4)ccc32)c2ccc(OCC3CO3)cc21]

According to another embodiment, Di-t-Butyl Hydroquinone can be reacted with epichlorohydrin to provide Di-t-Butyl Hydroquinone Diglycidyl Ether (DTBHQ-DGE) having the general chemical structure:

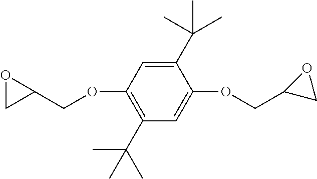 [SMILES: CC(C)(C)c1cc(OCC2CO2)c(C(C)(C)C)cc1OCC1CO1]

According to another embodiment, bis-(hydroxy phenyl)-N-phenyl isoindolinone can be reacted with epichlorohydrin to provide bis-(hydroxy phenyl)-N-phenyl isoindolinone diglycidyl ether having the general chemical structure:

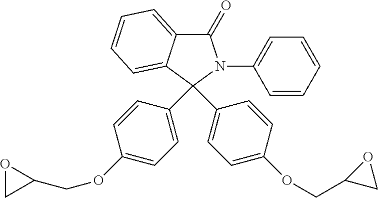 [SMILES: O=C1c2ccccc2C(c2ccc(OCC3CO3)cc2)(c2ccc(OCC3CO3)cc2)N1c1ccccc1]

According to another embodiment, tetra methyl bisphenol-A can be reacted with epichlorohydrin to provide tetra methyl bisphenol-A diglycidyl ether (TMBPA-DGE) having the general chemical structure:

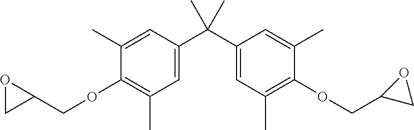 [SMILES: Cc1cc(C(C)(C)c2cc(C)c(OCC3CO3)c(C)c2)cc(C)c1OCC1CO1]

According to still another embodiment, by selection of an appropriate aromatic dihydroxy compound having a carboxylic acid functionality, the resulting epoxide can be an ether ester bis epoxide. For example, and without limitation, 4-hyroxybenzoic acid can be reacted with epichlorohydrin to provide diglycidyl benzoate having the general chemical structure:

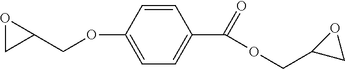 [SMILES: O=C(OCC1CO1)c1ccc(OCC2CO2)cc1]

The disclosed bis epoxide compounds are particularly well suited for use in the subsequent manufacture of polyepoxide compositions. To that end, the disclosed epoxides can be polymerized as homopolyepoxides comprised of a single bis epoxide monomer or as copolyepoxides comprising at least two or more different epoxide monomers. As one of ordinary skill in the art will appreciate, such polyepoxides can be formed by polymerizing one or more disclosed epoxides in the presence of any conventionally known epoxy curing or hardening agent. Exemplary non-limiting curing agents including for example conventional polyamines, acid hardeners, transition metal compounds, organometallic compounds, Lewis acids, mineral acids, sulfonic acids, carboxylic acids, carboxylic acid anhydrides, heterocyclic compounds, and any mixtures or combinations thereof. Any curing agent or hardener, or their decomposition products will lack any significant estradiol binding activity as characterized by a half maximal inhibitory concentration (IC₅₀), if any, that is not less than 0.00025M for alpha or beta in vitro estradiol receptors.

The disclosed polyepoxide and co-polyepoxide compositions can have any desired molecular weight. For example, disclosed polyepoxides can have molecular weights in the range of from 200 to 50,000 Daltons, including exemplary molecular weights of 300, 500, 1000, 3,000, 5,000, 10,000, 15,000, 20,000, 25,000, 30,000, 35,000, 40,000 and 45,000. In still further examples, the molecular weight of a disclosed polyepoxide can be in a range of from any one of the above mentioned values to any other of the above mentioned values. For example, molecular weight of a disclosed polyepoxide can be in the range of from 200 to 30,000 Daltons or from 300 to 30,000 Daltons. In still a further example, the molecular weight of a disclosed polyepoxide can be expressed as a value less than any one of the above disclosed values or, alternatively, can be expressed as a value greater than any one of the above disclosed values. For example, the molecular weight of a disclosed epoxide can be greater than 500 Daltons.

According to various embodiments, it should also be understood that the disclosed co-polyepoxides can be customized to provide any desired relative amounts of the various diepoxide comonomers. The relative mole ratio or mole percents among the various diepoxide monomeric components present in a copolymer will depend, in part, upon the total number of differing monomeric components present. The mole ratios can be expressed as relative mole percentages whereby the total mole percentage of monomeric components adds up to 100 mole %. For example, a copolymer comprising a blend of a first bisepoxide monomer and a second different bisepoxide monomer can be provided wherein the relative mole percentage ratio of the first monomer to the second monomer is 90 mole % to 10 mole %, 80 mole % to 20 mole %, 75 mole % to 25 mole %, 70 mole % to 30 mole %, 60 mole % to 40 mole %, or even 50 mole % to 50 mole %.

In addition to the polyepoxides discussed above, the bis epoxides of the present invention are also well suited for use as precursors or monomers in the manufacture of various epoxy resins. For example, epoxy resins (also known as phenoxy resins) can be conventionally prepared by polymerizing about a mole equivalent of an aromatic dihydroxy monomer component with about a mole of a bisepoxide monomer component. In another instance higher molar amounts of bis epoxide to bisphenols can be employed to give phenoxy resins with higher epoxy end group content. The aromatic dihydroxy component can be comprised of a single monomer or can comprise two or more such comonomers. Similarly, the bisepoxide component can comprise a single bisepoxide monomer or two or more such bisepoxide comonomers. By selecting an aromatic dihydroxy compound as described herein that exhibits little or no estradiol binding activity and by similarly selecting a bis epoxide of the present invention prepared from an aromatic dihydroxy compound as described herein, the resulting epoxy resin will itself exhibit little or no estradiol binding activity. Still further, if such an epoxy resin were subjected to conditions effective to result in hydrolytic or thermal degradation, or was contaminated with residual phenolic monomer, a resin extract would show little or no estradiol binding activity as characterized by a determination of the half maximal inhibitory concentration (IC₅₀) for the hydrolytic or thermolytic degradant, or the residual phenolic monomer. For example, such degradants or residual monomer, if any, resulting from such epoxy resins would not exhibit a half maximal inhibitory concentration (IC₅₀) less than 0.00025M for alpha or beta in vitro estradiol receptors. According to further embodiments, the resulting degradants or residual phenolic monomer would not exhibit a half maximal inhibitory concentration (IC₅₀) less than 0.0003M, 0.00035M, 0.0004M, 0.00045M, 0.0005M, 0.00075M, or even 0.001 M, for alpha or beta in vitro estradiol receptors. In still other embodiments, the resulting degradants or residual monomer would not exhibit any identifiable half maximal inhibitory concentration (IC₅₀) greater than or equal to about 0.00025M, 0.0003M, 0.00035M, 0.0004M, 0.00045M, 0.0005M, 0.00075M, or even 0.001 M, for alpha and/or beta in vitro estradiol receptors.

Similar to the polyepoxide and copolyepoxides described above, the disclosed epoxy resins can have any desired molecular weight. For example, epoxy resins of the invention can have molecular weights in the range of from 200 to 50,000 Daltons, including exemplary molecular weights of 300, 500,1000, 3,000, 5,000, 10,000, 15,000, 20,000, 25,000, 30,000, 35,000, 40,000 and 45,000. In still further examples, the molecular weight of a disclosed epoxy resin can be in a range of from any one of the above mentioned values to any other of the above mentioned values. For example, molecular weight of a disclosed epoxy resin can be in the range of from 200 to 30,000 Daltons, or from 300 to 30,000 Daltons. In still a further example, the molecular weight of a disclosed epoxy resin can be expressed as a value less than any one of the above disclosed values or, alternatively, can be expressed as a value greater than any one of the above disclosed values. For example, the molecular weight of a disclosed epoxy resin can be greater than 500 Daltons. Molecular weight can be determined by gel permeation chromatography (GPC) as described in American Society for Testing Materials (ASTM) method D5296.

Specific non-limiting examples of epoxy resins of the invention are illustrated below. In some embodiments, an epoxy resin homopolymers can be prepared by polymerizing a single aromatic dihydroxy monomer with a single corresponding bisepoxide, i.e., a bisepoxide formed from the selected aromatic dihydroxy compound. In some instance these polymers, reaction products of a bis epoxy compound with a bis phenol, are referred to as phenoxy resins. For example, resorcinol can be polymerized with resorcinol diglycidyl ether. The resulting epoxy resin structure is shown below, wherein “n” can be any desired integer based upon the desired chain length for the resin.

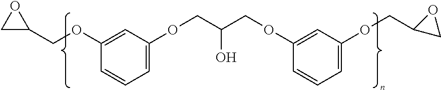

It is contemplated that this exemplified epoxy resin homopolymer, and others disclosed herein, can be obtained having a Mw in the range of from 388 to 50,000 Daltons; a phenolic group content less than 20 meq/kg; a chloride content less than 100 ppm; a transition metal content less than 20 ppm; and a residual monomer content less than 100 ppm.

In another embodiment, an epoxy resin homopolymer can be prepared by polymerizing Di-t-Butyl Hydroquinone and Di-t-Butyl Hydroquinone diglycidyl ether. The resulting epoxy resin structure is shown below, wherein “n” can be any desired integer based upon the desired chain length for the resin.

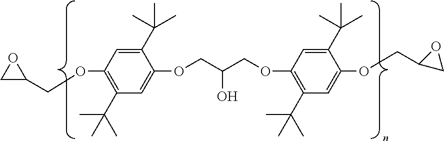

It is contemplated that this exemplified epoxy resin homopolymer, and others disclosed herein, can be obtained having a Mw in the range of from 612 to 50,000 Daltons; a phenolic group content less than 20 meq/kg; a chloride content less than 100 ppm; a transition metal content less than 20 ppm; and a residual monomer content less than 100 ppm.

In still another embodiment, an epoxy resin homopolymer can be prepared by polymerizing Spiro Biindane Bisphenol and Spiro Biindane Bis Phenol diglycidyl ether. The resulting epoxy resin structure is shown below, wherein “n” can be any desired integer based upon the desired chain length for the resin.

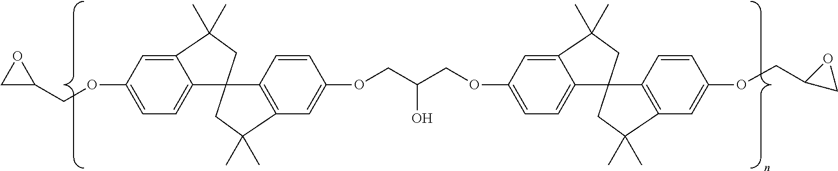

It is contemplated that this exemplified epoxy resin homopolymer, and others disclosed herein, can be obtained having a Mw in the range of from 784 to 50,000 Daltons; a phenolic group content less than 20 meq/kg; a chloride content less than 100 ppm; a transition metal content less than 20 ppm; and a residual monomer content less than 100 ppm.

In additional embodiments, an epoxy resin copolymer can be prepared by polymerizing a single aromatic dihydroxy monomer with a single bis epoxide, wherein the bis epoxide does not correspond to the selected aromatic dihydroxy compound, i.e., wherein the bisepoxide is formed from an aromatic dihydroxy compound other than the selected compound. For example, resorcinol and Spiro Biindane Bis Phenol diglycidyl ether can be polymerized. The resulting epoxy resin structure is shown below, wherein “n” can be any desired integer based upon the desired chain length for the resin.

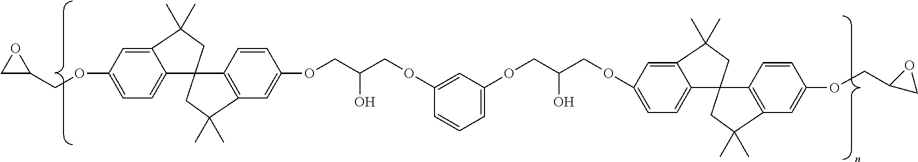

It is contemplated that this exemplified epoxy resin co-polymer, and others disclosed herein, can be obtained having a Mw in the range of from 950 to 50,000 Daltons; a phenolic group content less than 20 meq/kg; a chloride content less than 100 ppm; a transition metal content less than 20 ppm; and a residual monomer content less than 100 ppm.

In still another embodiment, an epoxy resin copolymer can be prepared by polymerizing Spiro Biindane Bis Phenol and resorcinol diglycidyl ether. The resulting epoxy resin structure is shown below, wherein “n” can be any desired integer based upon the desired chain length for the resin.

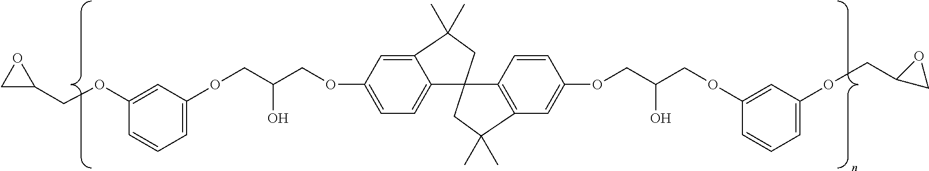

It is contemplated that this exemplified epoxy resin co-polymer, and others disclosed herein, can be obtained having a Mw in the range of from 752 to 50,000 Daltons; a phenolic group content less than 20 meq/kg; a chloride content less than 100 ppm; a transition metal content less than 20 ppm; and a residual monomer content less than 100 ppm.

In still another embodiment, an epoxy resin copolymer can be prepared by polymerizing Bis-(hydroxy phenyl)-N-phenyl isoindolinone and resorcinol diglycidyl ether. The resulting epoxy resin structure is shown below, wherein “n” can be any desired integer based upon the desired chain length for the resin.

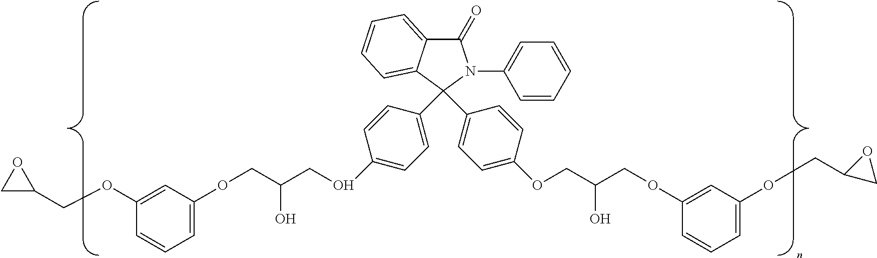

It is contemplated that this exemplified epoxy resin co-polymer, and others disclosed herein, can be obtained having a Mw in the range of from 837 to 50,000 Daltons; a phenolic group content less than 20 meq/kg; a chloride content less than 100 ppm; a transition metal content less than 20 ppm; and a residual monomer content less than 100 ppm.

In still further embodiments, an epoxy resin copolymer can be prepared by polymerizing two or more aromatic dihydroxy monomers and two or more bisepoxides. For example, resorcinol and di-t-butyl hydroquinone can be polymerized with resorcinol diglycidyl ether and di-t-butyl hydroquinone diglycidyl ether. The resulting epoxy resin copolymer structure is shown below, wherein “n” can be any desired integer based upon the desired chain length for the resin.

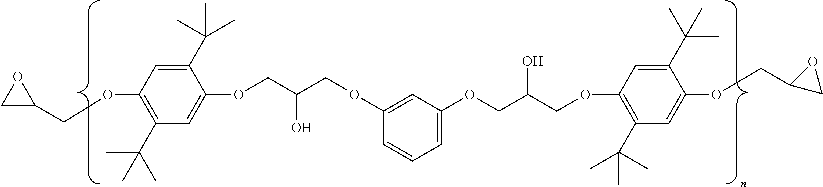

It is contemplated that this exemplified epoxy resin co-polymer, and others disclosed herein, can be obtained having a Mw in the range of from 500 to 50,000 Daltons; a phenolic group content less than 20 meq/kg; a chloride content less than 100 ppm; a transition metal content less than 20 ppm; and a residual monomer content less than 100 ppm.

The bisepoxides, polyepoxides, and epoxy resin polymers of the invention can optionally comprise one or more additives. Preferably, the one or more additive also does not exhibit a half maximal inhibitory concentration (IC₅₀) less than 0.00025M for alpha or beta in vitro estradiol receptors. To that end, exemplary and non-limiting additives that can be incorporated into the disclosed bisepoxides, polyepoxides, and epoxy resin polymers include stabilizers, antioxidants, colorants, impact modifiers, flame retardants, branching agents, cross linking agents, hardeners, UV screening additives, anti drip additives, mold release additives, lubricants, plasticizers, fillers, minerals, reinforcement additives such as carbon or glass fibers, or any combination thereof.

According to further embodiments, any one or more of the above referenced additives can be provided as a phosphorous containing compound. Exemplary phosphorous containing compounds include phosphites, phosphonates, phosphates, or a combination thereof. Thus, according to embodiments of the invention where phosphorous containing additives are present, it is preferable that the particular phosphorous containing additive similarly does not exhibit a half maximal inhibitory concentration (IC₅₀) less than 0.00025M for alpha or beta in vitro estradiol receptors. To that end, when such phosphorous containing additives are subjected to a hydrolysis reaction under conditions effective to provide one or more hydrolysis products, the hydrolysis product will similarly not exhibit a half maximal inhibitory concentration (IC₅₀) less than 0.00025M for alpha or beta in vitro estradiol receptors.

According to embodiments of the invention, suitable phosphite additives include diphenyl alkyl phosphites, phenyl dialkyl phosphites, trialkyl phosphites, dialkyl phosphites, triphenyl phosphites, diphenyl pentaerythritol diphosphite, or any combination thereof. The phosphite or phosphonate additives can be present in any desired or effective amount, when used the phosphite additives are preferably present in an amount in the range of from 0.00001 to 0.3 wt % phosphite, 0.00001 to 0.2 wt % phosphite, or even in the range of from 0.0001 to 0.01 wt % phosphite. Still further, it should be understood that a phosphorous containing additive such as a phosphite additive can have any desired molecular weight. However, according to a preferred embodiment, the phosphite additive has a molecular weight that is greater than 200 Daltons.

According to further embodiments of the invention the phosphorous containing compound is a phosphate. Suitable phosphate additives include triphenyl phosphate, resorcinol phenyl diphosphate, spirobiindane phenyl diphosphate, di-tertbutyl hydroquinone phenyl diphosphate, biphenol phenyl diphosphate, hydroquinone phenyl diphosphate, or any combination thereof

The phosphates are especially useful in flame retardant applications. To that end, in some embodiments aryl phosphates are preferred and may be used at 1 to 30 wt % of the composition. In other instances 5 to 20 wt % aryl phosphate will be present. In yet other instances the aryl phosphate will have a molecular weight from 300 to 1500 Daltons. It should also be understood that, in view of this disclosure, any additional suitable phosphorous containing additive, or hydrolysis product thereof, exhibiting a lack of estradiol binding activity characterized by the half maximal inhibitory concentration values described above can be used. The bisepoxides, polyepoxides, and epoxy resin polymers of the invention can further be blended with additional thermoplastic resins. For example, and without limitation, the disclosed compositions can be blended with rubber, polybutadiene, polyisoprene, chloroprene, polyvinyl chloride, polycarbonates, polyester carbonates, polyphenylene ethers, polysulfones, polyesters, styrene acrylonitrile (SAN), acrylonitrile butadiene styrene (ABS), methyl methacrylate (PMMA), methacrylate butadiene styrene (MBS), acrylic rubber, styrene maleic anhydride (SMA), styrene butadiene styrene (SBS), styrene ethylene butadiene styrene (SEBS), polystyrene, polyolefins, polyetherimides, polyetherimide sulfones or any combination thereof.

Residual monomer content can be measured using standard techniques, such as gas or liquid chromatography, on an extract of the polymer. The extract can also be titrated to determine phenolic content. Ionic chloride content can be determined for example by analysis of an aqueous extract of the polymer using for example ion chromatography (IC). Metals, including transition metals, and total chloride can be determined by pyrolysis/ashing of the epoxide sample followed by ion plasma chromatography (ICP) or other known techniques. Phenolic end groups of the polymer may be measured by known techniques such as titration, infrared spectroscopy (IR), and nuclear magnetic resonance (NMR). In one instance ³¹P NMR analysis using phosphorous functionalization of phenolic end groups can be was used to characterize the resins. Wherein the epoxide was dissolved in CDCl₃ with pyridine and chromium acetylacetonate (CrAcAc) and the phenolic hydroxyl groups are phosphorylated with o-phenylene phosphorochloridite (CAS# 1641-40-3).

The compositions of the present invention are well suited for use in a variety of applications, including any applications where conventional epoxides and polyepoxide compositions are currently used. To that end, exemplary uses and applications include coatings such as protective coatings, sealants, weather resistant coatings, scratch resistant coatings, and electrical insulative coatings; adhesives; binders; glues; composite materials such as those using carbon fiber and fiberglass reinforcements. When utilized as a coating, the compositions of the present invention can be deposited on a surface of a variety of underlying substrates. For example, the compositions of the present invention can be deposited on a surface of metals, plastics, glass, fiber sizings, ceramics, stone, wood, or any combination thereof. According to certain preferred embodiments, the disclosed compositions are particularly well suited for use as a coating on a surface of a metal container, such as those commonly used for packaging and containment in the paint and surface covering industries. In some instances the coated metal is aluminum or steel.

### EXAMPLES

The following examples are put forth so as to provide those of ordinary skill in the art with a complete disclosure and description of how the methods, devices, and systems disclosed and claimed herein are made and evaluated, and are intended to be purely exemplary and are not intended to limit the disclosure. Efforts have been made to ensure accuracy with respect to numbers (e.g., amounts, temperature, etc.), but normal experimental deviations should be allowed for. Unless indicated otherwise, parts are parts by weight, temperature is in C or is at ambient temperature, and pressure is at or near atmospheric. Examples of the invention are designated by numbers, control experiments are designated by letters.

Utilizing a conventional competitive binding assay as described above, estradiol binding activity as quantified by the half maximal inhibitory concentration (IC₅₀) value, was evaluated for various phenolic compounds capable of use as component starting materials in the manufacture of polyepoxide compositions. These component starting materials mimic or replicate various chemical species that could be resdiual phenolic monomers, or produced as hydrolysic or thermolytic degradation products derived from polyepoxides comprising the component starting materials. Specifically, (IC₅₀) binding concentrations for the alpha or beta in vitro estradiol receptors for various compounds were tested. Four separate sets of tests were run using a standard competitive binding assay. Samples were dissolved in either ethanol or DMSO. The various phenolic compounds were then tested at up to seven different concentrations for each test phenolic compound. Each of those tests was run in triplicate. Tests were conducted by displacement of a radio-ligand. For each set of tests a 17b-estradiol control sample was run to ensure proper binding of the natural hormone under the test conditions.

The polyepoxide hydrolysis or thermolysis product to be tested (Tables 1 to 4) was investigated as to its binding affinity for recombinant human estradiol receptors (rhER) alpha (α) and beta 1 (β1) in vitro. 17β-Estradiol (E₂) was used a standard whose relative binding affinity was defined as 100%. Competitive binding assays were performed by incubating rhER alpha (α) and beta 1 (β1) with 10 nM [³H]estradiol (radio ligand) in the presence or absence of increasing concentrations, 0.25 to 250,000 nM, of the phenolic test compounds of Tables 1 to 4 (nM is nano molar). Each data point is the average of at least two assays. Stock solutions of the compounds of Tables 1 to 4 were prepared at 10×10⁻² M in 100% ethanol, water or DMSO (dimethyl sulfoxide). Compounds were diluted 10 fold in binding buffer and then 1:4 in the final assay mix. The final concentration of ethanol or DMSO in the assay well was 5%. The highest concentration of the residual phenolic monomers or hydrolysis or thermolysis degradant test compounds was 2.5×10⁻⁴ M (250,000 nM). The potential hydrolysis or thermolysis compounds of Tables 1 to 4 were tested at up to seven concentrations over log increments. The lowest concentration was 2.5×10⁻¹⁰ M (0.25 nM). The IC₅₀ is the concentration of test substance at which about 50% of the radio labeled estradiol was displaced from the estradiol receptor.

In some very surprising instances (see Tables 1 to 4) the disparate phenolic compounds: tetra methyl bisphenol-A (TMBPA), phenol, N-phenyl phenolphthalein bisphenol (PPPBP), resorcinol, p-hydroxy benzoic acid (PHBA), biphenol (BP), spiro biindane bisphenol (SBIBP), di t-butyl hydroquinone (DTBHQ) and methyl hydroquinone show no estradiol binding, even at the highest concentration. In terms of their ability to bind to alpha or beta estradiol hormone receptors these phenolic compounds show a surprising reduction in activity. In some instances no binding can be measured using standard biochemical analysis techniques to test estradiol binding activity. That is, even at a concentration of 2.5×10⁻⁴ M there was no displacement of estradiol. Note that estradiol binds at very low concentrations of 1.0 to 14.7×10⁻⁹ M in our various control experiments and is much more active than any of the compounds tested.

The (IC₅₀) values obtained from these experiments are provided in the table below. As shown, many mono and bisphenols show an undesired high level of receptor binding. However very surprisingly the preferred phenolic compounds utilized to prepare the polyepoxide compositions of the invention (tetra methyl bisphenol-A (TMBPA), phenol, N-phenyl phenolphthalein bisphenol (PPPBP), resorcinol, p-hydroxy benzoic acid (PHBA), biphenol (BP), spiro biindane bisphenol (SBIBP), di t-butyl hydroquinone (DTBHQ) and methyl hydroquinone) either did not show any detectable estradiol binding in these tests or, at a minimum, did not exhibit an (IC₅₀) binding concentrations less than 2.5×10⁻⁴ M. An entry of >2.5×10⁻⁴ for compounds in Tables 1 to 4 indicates that those compounds did not compete to the extent of 50% with radio labeled 17B-estradiol at the highest concentration (250,000 nM) tested. That is there was no estradiol displacement and hence no IC₅₀ could be determined, the IC₅₀, if there is any displacement at all, is some value greater than 2.5×10⁻⁴.

The estradiol displacement experiments of set 1 (Table 1) show that the phenolic compounds; p-cumyl phenol (control example B), dihydroxy diphenyl ether (control example C), bisphenol acetophenone (control example D), dimethyl acetophenone bisphenol (control example E) and diphenolic acid methyl ester (control example F) all displace estradiol (control example A) at surprisingly low concentrations. However Example 1, p-hydroxy benzoic acid, shows no displacement at either the alpha or beta estradiol receptors at as high as 2.5×10⁻⁴ molar concentration.

TABLE 1
Experimental Set 1

| Example | Compounds | IC50 rhER alpha | IC50 rhER beta |
|---|---|---|---|
| A | 17b-estradiol control | 1.0 × E−9 | 8.2 × E−9 |
| B | p-Cumyl Phenol (CAS# 599-64-4) | 1.4 × E−4 | 9.8 × E−6 |
| C | Dihydroxy Diphenyl Ether (CAS# 1965-09-9) | 6.0 × E−5 | 1.4 × E−5 |
| D | Bisphenol Acetophenone (CAS# 1571-75-1) | 1.2 × E−5 | 1.4 × E−6 |
| E | Dimethyl Acetophenone Bisphenol (CAS# 4754-63-6) | 4.8 × E−6 | 3.5 × E−6 |
| F | Diphenolic Acid Methyl Ester (CAS# 7297-85-0) | 1.9 × E−5 | 1.1 × E−5 |
| 1 | p-Hydroxy Benzoic Acid CAS# 99-96-7) | >2.5 × E−3 | >2.5 × E−3 |

| | |
|---|---|
| IC50 is the conc. Of the candidate that displaces 50% | >2.5 × E4 compounds did not compete |
| of the radioactive ligand from the rhER cells | to the extent of 50% with radiolabeled |
| | 17B-estradiol at the highest conc. |
| | (250,000 nM) tested, no IC50 |
| | can be determined |

In second set of experiments (Table 2) phenolic compounds structurally similar to, but not identical to those of set 1, were tested as to their ability to displace estradiol. Surprisingly tetra methyl BPA (Example 2), phenol (Example 3), N-phenolphthalein bisphenol (Example 4) and resorcinol (Example 5) show no detectible estradiol displacement at either the alpha or beta estradiol receptor at as high as 2.5×E-4 molar concentration. On the other hand dimethyl cyclohexyl bisphenol (control example H) and the closely structurally related compounds of control examples B to F (Table 1) all show displacement of estradiol at both the alpha or beta receptors at lower concentration. The estradiol binding of phenolic compounds seems to be very unpredictable. It does not correlate with molecular weight, phenolic group separation, molecular rigidity, solubility, steric hindrance or electronic effects.

Note that while the phenolic compounds of our invention show no displacement at the alpha or beta estradiol binding sites at concentration below the 2.5×E-4 limit of detection, even the control examples, while showing some binding, are not as reactive as estradiol (control examples A and G). 17b-Estradiol binds at a very low concentration.

TABLE 2
Experimental Set 2

| Example | Compounds | IC50 rhER alpha | IC50 rhER beta |
|---|---|---|---|
| G | 17b-estradiol control | 10.0 × E−9 | 6.4 × E−9 |
| H | Dimethyl Cyclohexyl Bisphenol (CAS# 2362-14-3) | 1.3 × E−6 | 3.1 × E−6 |
| 2 | Tetra Methyl BPA (CAS# 5613-46-7) | >2.5 × E−4 | >2.5 × E−4 |
| 3 | Phenol (CAS# 108-95-2) | >2.5 × E−4 | >2.5 × E−4 |
| 4 | N-Phenyl Phenolphthalein Bisphenol (CAS# 6607-41-6) | >2.5 × E−4 | >2.5 × E−4 |
| 5 | Resorcinol (CAS# 108-46-3) | >2.5 × E−4 | >2.5 × E−4 |

| | |
|---|---|
| IC50 is the conc. of the candidate that displaces 50% | >2.5 × E4 compounds did not compete |
| of the radioactive ligand from the rhER cells | to the extent of 50% with radiolabeled |
| | 17B-estradiol at the highest conc. |
| | (250,000 nM) tested, no IC50 |
| | can be determined |

In a further set of experiments (Table 3) the surprising and unpredictable trend of estradiol displacement is again observed. The bis phenolic compounds: fluorenone bis o-cresol (control example J), hydro isophorone bisphenol (control example K), bisphenol M (control example L), and bis hydroxy phenyl menthane (control example M) all displace estradiol at low concentrations. On the other hand, spiro biindane bisphenol (Example 6), biphenol (Example 7) and di-2,5-tert-butyl hydroquinone (Example 8) all show no displacement of the estradiol at the alpha receptor at 2.5×E-4 M concentration. Examples 6 and 8 also show no displacement at the beta receptor.

TABLE 3
Experimental Set 3

| Example | Compounds | IC50 rhER alpha | IC50 rhER beta |
|---|---|---|---|
| I | 17b-estradiol control | 7.0 × E−9 | 6.6 × E−9 |
| J | Fluorenone Bis o-Cresol (CAS# 88938-12-9) | 9.7 × E−6 | 2.5 × E−5 |
| K | Hydro Isophorone Bisphenol (CAS# 129188-99-4) | 4.5 × E−7 | 1.1 × E−6 |
| L | Bisphenol M (CAS# 13595-25-0) | 2.1 × E−6 | 1.4 × E−6 |
| M | Bis Hydroxy Phenyl Menthane (CAS# 58555-74-1) | 4.9 × E−7 | 6.7 × E−7 |
| 6 | Spiro Biindane Bisphenol (CAS# 1568-80-5) | >2.5 × E−4 | >2.5 × E−4 |
| 7 | Biphenol (CAS# 92-88-6) | >2.5 × E−4 | 1.7 × E−6 |
| 8 | Di t-Butyl Hydroquinone (CAS# 88-58-4) | >2.5 × E−4 | >2.5 × E−4 |

| | |
|---|---|
| IC50 is the conc. of the candidate that displaces | >2.5 × E4 compounds did not compete |
| 50% of the radioactive ligand from the rhER cells | to the extent of 50% with radiolabeled |
| | 17B-estradiol at the highest conc. |
| | (250,000 nM) tested, no IC50 |
| | can be determined |

In yet another set of experiments (Table 4) undesirable estradiol displacement at low concentration is observed for the bisphenols benzophenone bisphenol (control example O) and phenolphthalein (control example P) while methyl hydroquinone (Example 9) surprisingly shows no alpha or beta estradiol displacement at as high as 2.5×E-4 molar concentration. As in the other sets of experiments (Tables 1 to 3) an estradiol control (example N) was run as part of the set to establish a baseline of estradiol displacement. Estradiol displaces at much lower concentration than any of the phenolic compounds.

TABLE 4
Experimental Set 4

| Example | Compounds | IC50 rhER alpha | IC50 rhER beta |
|---|---|---|---|
| N | 17b-estradiol control | 10.0 × E−9 | 14.7 × E−9 |
| O | Benzophenone bisphenol (CAS# 611-99-4) | 3.1 × E−5 | 3.2 × E−6 |
| P | Phenolphthalein (CAS# 77-09-8) | 3.7 × E−6 | 1.4 × E−5 |
| 9 | Methyl Hydroquinone (CAS# 95-71-6) | >2.5 × E−4 | >2.5 × E−4 |

| | |
|---|---|
| IC50 is the conc. of the candidate that | >2.5 × E4 compounds did not compete |
| displaces 50% of the radioactive ligand | to the extent of 50% with radiolabeled |
| from the rhER cells | 17B-estradiol at the highest conc. |
| | (250,000 nM) tested, no IC50 |
| | can be determined |

What is claimed is:

1. A polyepoxide composition, comprising:
a polymerized bisepoxide, wherein the bisepoxide is derived from a phenolic compound that does not exhibit a half maximal inhibitory concentration (IC₅₀) less than 0.00025M for alpha or beta in vitro estradiol receptors, and
wherein when the polymerized bisepoxide is subjected to conditions effective to provide one or more degradation products, each of the one or more degradation products does not exhibit a half maximal inhibitory concentration (IC₅₀) less than 0.00025M for alpha or beta in vitro estradiol receptors.

2. The polyepoxide composition of claim 1, wherein the phenolic compound does not exhibit a half maximal inhibitory concentration (IC₅₀) greater than or equal to 0.00025M for alpha or beta in vitro estradiol receptors.

3. The polyepoxide composition of claim 2, wherein the phenolic compound comprises a bisphenolic compound.

4. The polyepoxide composition of claim 1, wherein the phenolic compound comprises resorcinol, hydroquinone, methyl hydroquinone, t-butyl hydroquinone, di-t-butyl hydroquinones (DTBHQ), biphenols, tetramethyl bisphenol-A, spiro biindane bisphenols (SBIBP), or bis-(hydroxy aryl)-N-aryl isoindolinones, hydroxy benzoic acids or any combination thereof.

5. The polyepoxide composition of claim 1, wherein the polyepoxide is a co-polyepoxide comprising two or more polymerized bisepoxides and wherein each of the two or more bisepoxides is derived from a phenolic compound that does not exhibit a half maximal inhibitory concentration (IC₅₀) less than 0.00025M for alpha or beta in vitro estradiol receptors.

6. The polyepoxide composition of claim 1, further comprising one or more additives and wherein each of the one or more additives does not exhibit a half maximal inhibitory concentration (IC₅₀) less than 0.00025M for alpha or beta in vitro estradiol receptors.

7. The polyepoxide composition of claim 6, wherein the one or more additive comprises a stabilizer, antioxidant, colorant, impact modifier, flame retardant, branching agent, cross linking agent, hardeners, curing agents, UV screening additive, anti drip additive, mold release additive, lubricant, plasticizer, filler, mineral, reinforcement additive, or any combination thereof.

8. The polyepoxide composition of claim 7, wherein the one or more additive comprises a phosphorous containing compound.

9. The polyepoxide composition of claim 7, wherein the one or more additive comprises a curing agent comprising an acid, amine or carboxylic acid anhydride.

10. The polyepoxide composition of claim 1, further comprising:
a) a Mw in the range of from 200 to 30,000 Daltons;
b) a phenolic end group content less than 20 meq/kg;
c) a total chloride content less than 100 ppm;
d) a transition metal content less than 20 ppm; and
e) a residual phenolic monomer content less than 100 ppm.

11. An article of manufacture, comprising:
a) a substrate; and
b) a polyepoxide film deposited on a surface of the substrate, wherein the polyepoxide film comprises the polyepoxide composition of claim 1.

12. The article of manufacture of claim 11, wherein the substrate is comprised of metals, plastics, glass, ceramics, wood, or any combination thereof.

13. The article of manufacture of claim 11, wherein the substrate comprises a metal container.

14. The article of manufacture of claim 13, wherein the metal container is comprised of aluminum or steel.

15. An epoxy resin composition, comprising:
a copolymerized bisepoxide component and a phenolic monomer component,
wherein the bisepoxide component comprises a bisepoxide compound derived from a first phenolic compound that does not exhibit a half maximal inhibitory concentration (IC₅₀) less than 0.00025M for alpha or beta in vitro estradiol receptors,
wherein the phenolic monomer component comprises a second phenolic compound that does not exhibit a half maximal inhibitory concentration (IC₅₀) less than 0.00025M for alpha or beta in vitro estradiol receptors, and
wherein when the epoxy resin composition is subjected to conditions effective to provide one or more degradation products, each of the one or more degradation products does not exhibit a half maximal inhibitory concentration (IC₅₀) less than 0.00025M for alpha or beta in vitro estradiol receptors.

16. The epoxy resin composition of claim 15, wherein the bisepoxide compound is derived from a bisphenolic compound.

17. The epoxy resin composition of claim 15, wherein the first phenolic compound and the second phenolic compound are the same.

18. The epoxy resin composition of claim 15, wherein the first and second phenolic compounds each comprise resorcinol, hydroquinone, methyl hydroquinone, t-butyl hydroquinone, di-t-butyl hydroquinones (DTBHQ), biphenols, tetramethyl bisphenol-A, spiro biindane bisphenols (SBIBP), bis-(hydroxy aryl)-N-aryl isoindolinones, hydroxy benzoic acids or any combination thereof.

19. The epoxy resin composition of claim 15, wherein the bisepoxide component comprises two or more bisepoxides and wherein each of the two or more bisepoxides is derived from a phenolic compound that does not exhibit a half maximal inhibitory concentration (IC₅₀) less than 0.00025M for alpha or beta in vitro estradiol receptors.

20. The epoxy resin composition of claim 15, wherein the phenolic monomer component comprises two or more phenolic compounds and wherein each of the two or more aromatic dihydroxy compounds does not exhibit a half maximal inhibitory concentration (IC₅₀) less than 0.00025M for alpha or beta in vitro estradiol receptors.

21. The epoxy resin composition of claim 15, further comprising one or more additives and wherein each of the one or more additives does not exhibit a half maximal inhibitory concentration (IC₅₀) less than 0.00025M for alpha or beta in vitro estradiol receptors.

22. The epoxy resin composition of claim 21, wherein the one or more additive comprises a stabilizer, antioxidant, colorant, impact modifier, flame retardant, branching agent, cross linking agent, hardeners, curing agents, UV screening additive, anti drip additive, mold release additive, lubricant, plasticizer, filler, mineral, reinforcement additive, or any combination thereof.

23. The epoxy resin composition of claim 21, wherein the one or more additive comprises a phosphorous containing compound.

24. The epoxy resin composition of claim 21 wherein the one or more additive comprises a curing agent comprising an acid, amine or carboxylic acid anhydride.

25. The epoxy resin composition of claim 15, further comprising:
a) a Mw in the range of from 200 to 30,000 Daltons;
b) a phenolic end group content less than 20 meq/kg;
c) a total chloride content less than 100 ppm;
d) a transition metal content less than 20 ppm; and
e) a residual phenolic monomer content less than 100 ppm.

26. An article of manufacture, comprising:
a) a substrate; and
b) an epoxy resin film deposited on a surface of the substrate, wherein the epoxy resin film comprises the epoxy resin composition of claim 15.

27. The article of manufacture of claim 26, wherein the substrate is comprised of metals, plastics, glass, ceramics, wood, or any combination thereof.

28. The article of manufacture of claim 26, wherein the substrate comprises a metal container.

29. The article of manufacture of claim 28, wherein the metal container is comprised of aluminum or steel.

30. A method for the manufacture of a polyepoxide composition, comprising:
a) providing a phenolic compound that does not exhibit a half maximal inhibitory concentration (IC₅₀) less than 0.00025M for alpha or beta in vitro estradiol receptors;
b) reacting the provided phenolic compound with an epoxide forming reactant to provide a bisepoxide derived from the aromatic dihydroxy compound; and
c) polymerizing the bisepoxide to provide a polyepoxide composition having a predetermined molecular weight.

31. The method of claim 30, wherein the phenolic compound comprises a bisphenolic compound.

32. The method of claim 30, wherein the phenolic compound comprises resorcinol, hydroquinone, methyl hydroquinone, t-butyl hydroquinone, di-t-butyl hydroquinones (DTBHQ), biphenols, tetramethyl bisphenol-A, Spiro biindane bisphenols (SBIBP), bis-(hydroxy aryl)-N-aryl isoindolinones, hydroxy benzoic acids, or any combination thereof.

33. The method of claim 30, wherein step a) comprises providing a first and a second phenolic compound, wherein step b) comprises reacting the first and second phenolic compounds with an epoxide forming reactant to provide a first bisepoxide derived from the first phenolic compound and a second bisepoxide derived from the second phenolic compound; and wherein step c) comprises co-polymerizing the first and second bisepoxides to provide a copolyepoxide composition having a predetermined molecular weight.

34. The method of claim 30, wherein the epoxide forming reactant comprises epichlorohydrin.

35. A method for the manufacture of an epoxy resin, comprising:
a) providing a first phenolic compound that does not exhibit a half maximal inhibitory concentration (IC₅₀) less than 0.00025M for alpha or beta in vitro estradiol receptors;
b) reacting the first phenolic compound with an epoxide forming reactant to provide a bisepoxide derived from the phenolic compound;
c) providing a second phenolic compound that does not exhibit a half maximal inhibitory concentration (IC₅₀) less than 0.00025M for alpha or beta in vitro estradiol receptors;
d) copolymerizing the bisepoxide and second phenolic compound to provide an epoxy resin composition having a predetermined molecular weight.

36. The method of claim 35, wherein the first and second phenolic compounds comprise a bisphenolic compound.

37. The method of claim 36, wherein the first phenolic compound and the second phenolic compound are the same compound.

38. The method of claim 35, wherein the first phenolic compound comprises resorcinol, hydroquinone, methyl hydroquinone, t-butyl hydroquinone, di-t-butyl hydroquinones (DTBHQ), biphenols, tetramethyl bisphenol-A, spiro biindane bisphenols (SBIBP), bis-(hydroxy aryl)-N-aryl isoindolinones, hydroxy benzoic acids or any combination thereof.

39. The method of claim 35, wherein the epoxide forming reactant comprises epichlorohydrin.
